(19) United States
(12) Patent Application Publication
(10) Pub. No.: US 2024/0170712 A1
(43) Pub. Date: May 23, 2024

(54) BATTERY INCLUDING FOLDED FOIL PORTION AND METHOD OF FABRICATING SAME

(71) Applicant: TECHTRONIC CORDLESS GP, Anderson, SC (US)

(72) Inventors: Aditya SUBRAMANIAN, Hong Kong (CN); Denis Gaston FAUTEUX, Hong Kong (CN); Dan GENG, Dongguan City (CN); Jin Wei LI, Dongguan City (CN)

(21) Appl. No.: 18/551,536

(22) PCT Filed: Apr. 29, 2021
(86) PCT No.: PCT/CN2021/091063

§ 371 Date: Sep. 20, 2023

(51) Int. Cl. H01M 10/04; H01M 4/04; H01M 10/0525; H01M 50/403; H01M 50/463

(52) U.S. Cl. CPC H01M 10/0431; H01M 4/0404; H01M 10/0525; H01M 50/403; H01M 50/463

(57) ABSTRACT

A battery includes an anode, a cathode, one or more separators, and an electrolyte. The anode, the cathode, the one or more separators, and the electrolyte are disposed in a roll configuration. At least one of the anode or the cathode includes a foil portion having a plurality of bent portions in different widths that are bent inwardly toward an axis of the roll configuration and that define an edge of the roll configuration.

### TECHNICAL FIELD

This disclosure is generally related to batteries, and more particularly, to battery electrodes.

### BACKGROUND

The use of various forms of batteries has become nearly ubiquitous in today's world. As more and more portable or cordless devices, such as power tools (e.g., drills, saws, grass trimmers, blowers, sanders, etc.), small appliances (e.g., mixers, blenders, coffee grinders, etc.), communications devices (e.g., smartphones, personal digital assistants, etc.), and office equipment (e.g., computers, tablets, printers, etc.), are in widespread use, the use of battery technologies of varying chemistry and configuration is commonplace.

Lithium-ion battery (LiB) configurations have gained popularity in recent years for use with respect to portable or cordless devices. LiBs may have a higher energy density than certain other rechargeable battery configurations (e.g., nickel-cadmium (NiCd) batteries), may have no memory effect, and may experience low self-discharge. As a result, LiBs provide a rechargeable battery configuration commonly utilized in today's portable or cordless devices.

The size and weight of portable or cordless devices is often an important consideration. As the size and weight of an on-board rechargeable battery system, which may include multiple individual batteries in the form of a battery pack, often contributes appreciably to the overall size and weight of the portable or cordless device, the size and weight of rechargeable batteries can be important in the design of the host devices. Reducing the size and weight of batteries (such as LiBs and other batteries) while maintaining relatively high battery energy density may increase cost of battery manufacture. For example, as the size and weight of a battery are reduced, features of the battery may be more subject to damage during a battery manufacturing process, which may reduce product yield and increase cost of the battery manufacturing process.

### SUMMARY

In some aspects of the disclosure, a battery manufacturing process includes forming a shaped pattern on a foil portion of an electrode (such as a cathode or an anode) of a battery. The shaped pattern may include regions that are shaped based on a “stepped” or “staircase” pattern, where the regions increase in width from a first end of the foil portion to a second end of the foil portion (e.g., where a region adjacent to the first end has less width than other regions, and where a region adjacent to the second end has greater width than other regions). The battery manufacturing process may include forming, in each of the regions of the shaped pattern, one or more strips (or “flags”), such as by laser cutting incisions in the shaped pattern.

After performing a winding process to create a roll configuration (such as a “jellyroll” configuration) of the battery, a folding process may be performed to bend (or crimp) the strips inwardly toward an axis of the roll configuration. In some implementations, performing the folding process may include using a rotary tool (such as a rotary blade) to apply force to fold in the strips inwardly toward the axis of the roll configuration. After folding the strips using the folding process, the folded strips may be used as a connection terminal to one or more other components of the battery or of a device that includes the battery. For example, a weld plate may be welded to the strips, and the weld plate may be connected to a can or to a header associated with the battery.

By performing the folding process, in some implementations, an edge of the roll configuration may be smoothed without use of a rubbing process to planarize the edge of the roll configuration. As a result, wear that may result from the rubbing process in some circumstances (such as physical damage resulting from rubbing the foil portion of the electrode) may be avoided. In addition, use of the folding process instead of the rubbing process may reduce cost of the battery manufacturing process, such as in implementations where implementation of a laser cutting process to form the regions and strips is less expensive than implementation of a rubbing process, which may involve specialized hardware, tools, and equipment. In some cases, because a rubbing process may be associated with product damage or wear, use of the folding process instead of a rubbing process may avoid certain product damage or wear during manufacturing, increasing product yield associated with the battery fabrication process.

Further, in some implementations, an impedance associated with the battery may be reduced or determined based on a number of the strips formed in the shaped pattern. For example, if the electrode is connected to a can or header, then an impedance between the electrode and the can or header may be inversely proportional to the number of strips formed in the shaped pattern. As a result, in some implementations, performing the folding process using the strips formed in the shaped pattern may enable the impedance of the battery to be changed (e.g., decreased), which may increase energy density associated with the battery.

The foregoing has outlined rather broadly some examples and technical advantages in order that the detailed description that follows may be better understood. Additional examples and advantages will also be described hereinafter. It should be appreciated by those skilled in the art that the examples disclosed may be utilized as a basis for modifying or designing other structures for carrying out the same purposes. It should also be realized by those skilled in the art that such constructions do not depart from the spirit and scope as set forth herein. The examples that follow will be better understood from the following description when considered in connection with the accompanying figures. It is to be expressly understood, however, that each of the figures is provided for the purpose of illustration and description.

### BRIEF DESCRIPTION OF THE DRAWINGS

FIG. 1A is a diagram illustrating certain aspects associated with an example of a battery fabrication process.

FIG. 1B illustrates certain additional aspects associated with an example of a battery fabrication process.

FIG. 1C illustrates certain additional aspects associated with an example of a battery fabrication process.

FIG. 1D illustrates certain additional aspects associated with an example of a battery fabrication process.

FIG. 1E illustrates certain additional aspects associated with an example of a battery fabrication process.

FIG. 1F illustrates certain additional aspects associated with an example of a battery fabrication process.

FIG. 1G illustrates certain additional aspects associated with an example of a battery fabrication process.

FIG. 1H illustrates certain additional aspects associated with an example of a battery fabrication process.

FIG. 1I illustrates certain additional aspects associated with an example of a battery fabrication process.

FIG. 1J illustrates certain additional aspects associated with an example of a battery fabrication process.

FIG. 2 is a flow chart illustrating an example of a method of battery fabrication.

### DETAILED DESCRIPTION

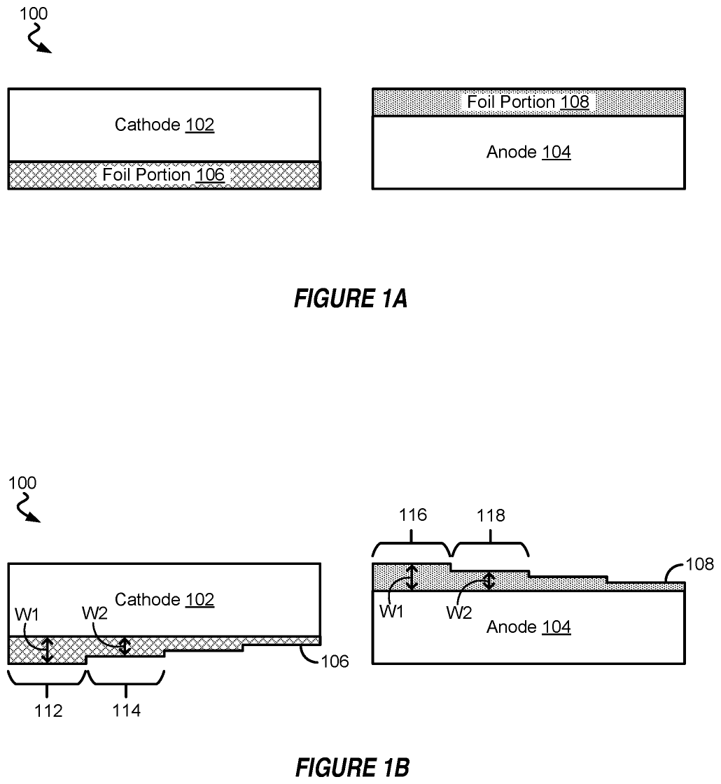

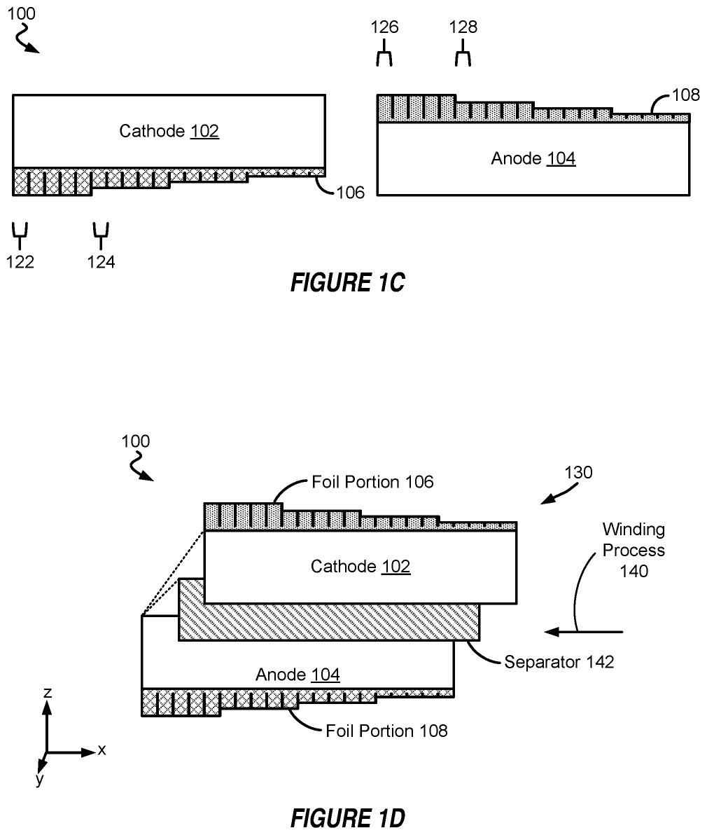

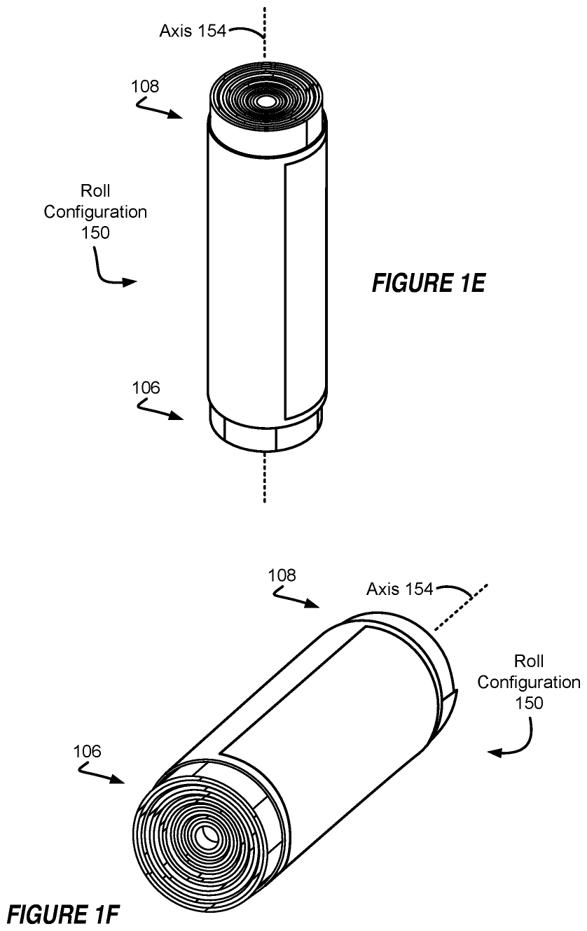

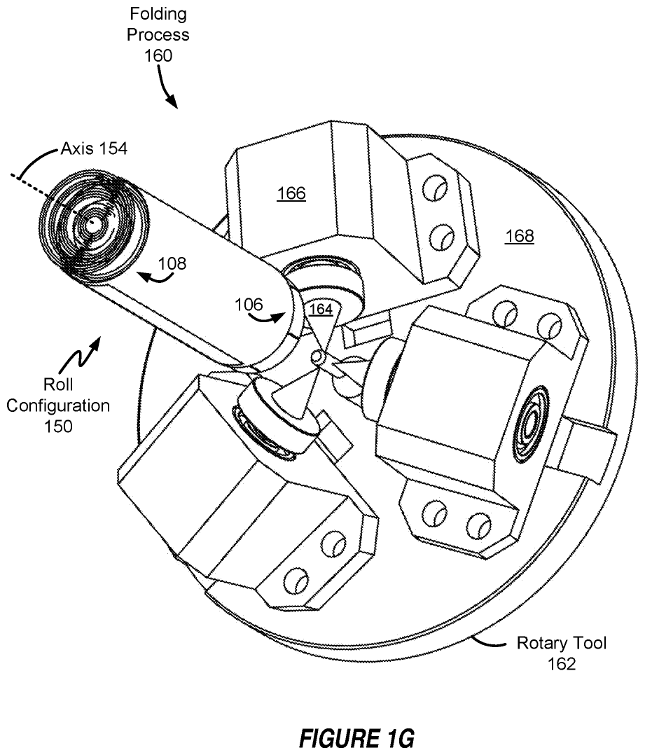

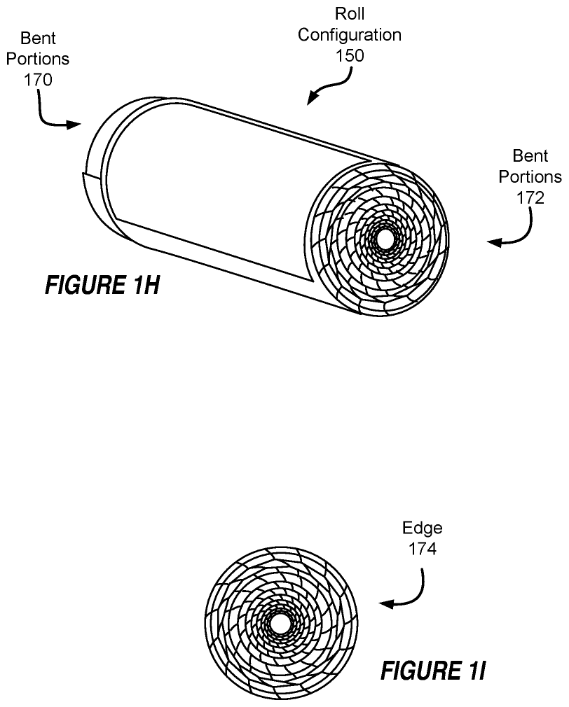

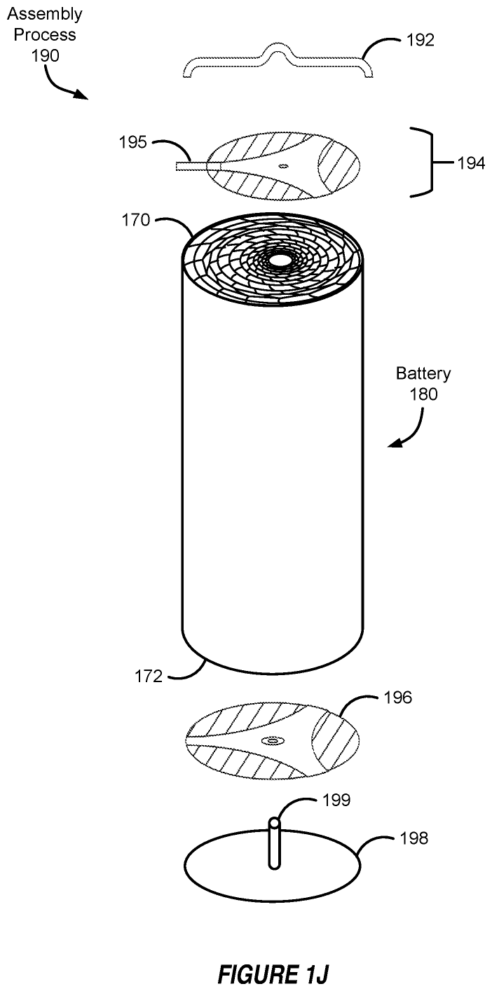

FIG. 1A is a diagram illustrating certain aspects associated with an example of a battery fabrication process 100. The battery fabrication process 100 may include forming a first electrode (e.g., one of a cathode 102 or an anode 104) and a second electrode (e.g., the other of the cathode 102 or the anode 104). A foil portion 106 or foil portion may be formed on the cathode 102, and a foil portion 108 or foil portion may be formed on the anode 104. In one embodiment, the cathode 102 is manufactured by coating a cathode material on a foil while leaving a bare foil portion. The bare foil portion becomes the foil portion 106. Similarly, the anode 104 is manufactured by coating an anode material on a foil while leaving a bare foil portion which becomes the foil portion 108.

FIG. 1B is a diagram illustrating certain aspects associated with an example of the battery fabrication process 100. FIG. 1B illustrates that the battery fabrication process 100 may include forming a plurality of regions on the foil portion 106 of the cathode 102, on the foil portion 108 of the anode 104, or both. In some examples, each plurality of regions may be created by removing material of the foil portions 106, 108, such as by cutting (e.g., laser cutting), drilling, planarizing, die cutting, or etching the foil portions 106, 108. For example, a plurality of regions formed on the foil portion 106 of the cathode 102 may include a first region 112 and a second region 114. As another example, a plurality of regions formed on the foil portion 108 of the anode 104 may include a first region 116 and a second region 118. In some examples, each plurality of regions may correspond to a stepped pattern, and each region may correspond to a step of the stepped pattern. To further illustrate, the first region 112 may have a first width W1, and the second region 114 may have a second width W2 that is different than (e.g., less than) the first width W1. The first region 116 may have a third width (e.g., the first width W1 or another width), and the second region 118 may have a fourth width (e.g., the second width W2 or another width) that is different than (e.g., less than) the third width. In some examples, the plurality of regions may correspond to a curve pattern or a linear pattern. In a linear pattern, the angle between the edge of the foil portion and the longitudinal direction (axis x) may be within 3-20 degrees, such as 5 degrees, 10 degrees, or 13 degrees.

FIG. 1C is a diagram illustrating certain aspects associated with an example of the battery fabrication process 100. FIG. 1C illustrates that the battery fabrication process 100 may include forming a plurality of strip portions on the plurality of regions of the cathode 102, forming a plurality of strip portions on the plurality of regions of the anode 104, or both. In some examples, the strip portions may be created by removing material of the foil portions 106, 108, such as by cutting (e.g., laser cutting or die cutting), drilling, scoring, or etching incisions, holes, or cavities within the foil portions 106, 108. To illustrate, the battery fabrication process 100 may include forming a plurality of strip portions in the foil portion 106 including one or more first strip portions in the first region 112 (such as a representative first strip portion 122) and including one or more second strip portions in the second region 114 (such as a representative second strip portion 124). As another example, the battery fabrication process 100 may include forming a plurality of strip portions in the foil portion 108 including one or more first strip portions in the first region 116 (such as a representative first strip portion 126) and including one or more second strip portions in the second region 118 (such as a representative second strip portion 128). In some implementations, forming the strip portions in the foil portions 106, 108 may include forming incisions in the foil portions 106, 108 using a laser cutting process.

FIG. 1D is a diagram illustrating certain aspects associated with an example of the battery fabrication process 100. FIG. 1D also illustrates a top view 130 of the cathode 102, which is above (e.g., in the y direction) and partially obscures the anode 104 and one or more separators (hereinafter referred to as separator 142) between the cathode 102 and the anode 104. In the top view 130, the foil portion 106 may be offset from (e.g., may extend over in the z direction) the cathode 102, and the foil portion 108 may be offset from (e.g., may extend over in the negative z direction) the anode 104. Further, although FIG. 1D depicts that the cathode 102, the separator 142, and the anode 104 are offset in the x direction for illustration, it is noted that the cathode 102, the separator 142, and the anode 104 may be aligned in the x direction (indicated in FIG. 1D with dashed lines).

FIG. 1D also illustrates that the battery fabrication process 100 may include performing a winding process 140. For example, the cathode 102 (and the foil portion 106) and the anode 104 (and the foil portion 108) are separated by the separator 142 and may be rolled or wound via the winding process 140 to create a roll configuration (such as a cylindrical “jellyroll” configuration). To further illustrate, the rightmost edge in FIG. 1D may be rolled toward the negative x direction so that regions of the foil portions 106, 108 having small width are inside of regions of the foil portions 106, 108 having larger width. For example, the regions 114, 118 may be inside of the regions 112, 116 within the roll configuration. In one example, the regions having the same width form a sustainably circular shape after winding. Therefore, when viewing from the end surface, there will be several circular shape in different widths, with highest width at the outmost circle and lowest width at the innermost circle. Regions having different widths are arranged along a radial direction toward the axis 154 (shown in FIGS. 1E and 1F).

In one embodiment, the cathode 102, the separator 142, and the anode 104 will be supplied to a rolling station where these three layers are wound together into a jelly roll configuration. If necessary, a pin or tube can be provided so that the cathode 102, the separator 142, and the anode 104 can be wound around the pin. The pin or tube will be removed after the winding process.

FIGS. 1E and 1F illustrate certain additional aspects associated with an example of the battery fabrication process 100. In FIGS. 1E and 1F, the cathode 102 (and the foil portion 106), the anode 104 (and the foil portion 108), and the separator 142 are disposed in a roll configuration 150 (e.g., a cylindrical “jellyroll” configuration created using the winding process 140). In the roll configuration 150, the cathode 102 and the anode 104 may be juxtaposed as facing spirals to form a cylindrical cell. The roll configuration 150 may include the separator 142 disposed between facing surfaces of the cathode 102 and the anode 104. In some examples, a tape or other material may be applied to an external surface of the roll configuration 150 to increase stability associated with the roll configuration 150 (e.g., by preventing unraveling of the roll configuration 150 in some circumstances).

FIG. 1G illustrates certain additional aspects associated with an example of the battery fabrication process 100. After performing the winding process 140, the battery fabrication process 100 may include performing a folding process 160 to fold, bend, or crimp the plurality of strip portions of the cathode 102, to fold, bend, or crimp the plurality of strip portions of the anode 104, or both. To further illustrate, bending each plurality of strip portions radially inwardly toward the axis 154 of the roll configuration 150 may include sequentially applying forces to the plurality of strip portions using a rotary tool 162 as illustrated in the example of FIG. 1G. As referred to herein, bending portions “radially inwardly” may include folding, bending, crimping, or repositioning the portions from an outside of the roll configuration 150 toward an inside of the roll configuration 150 (e.g., along a circumference of the roll configuration 150), which may result in a flat surface or a substantially flat surface in some implementations.

FIG. 1G illustrates that the rotary tool 162 may include one or more tips (such as an example tip 164). In some examples, the rotary tool 162 includes three tips 164, such as illustrated in the example of FIG. 1G. In other examples, the rotary tool 162 includes a different number of tips 164. Further, in some examples, one or more tips 164 of the rotary tool 162 may have a conical shape, such as illustrated in the example of FIG. 1G. In other examples, one or more tips 164 of the rotary tool 162 may have a different shape.

Each tip 164 may be driven by a corresponding motor 166 of the rotary tool 162 that rotates the tip 164 about an axis of the tip 164. In some examples, the axis extends through an apex of a conical shape that may associated with or defined by the tip 164. In some examples, each motor 166 is coupled to a base 168 of the rotary tool 162.

During the folding process 160, the rotary tool 162 may apply force to the foil portions of the roll configuration 150 via the tips 164. To illustrate, the rotary tool 162 may fold outer strip portions (having greater width) inwardly toward the axis 154 of the roll configuration 150 before folding inner strip portions (having less width) inwardly toward the axis 154 of the roll configuration 150. For example, the first strip portion 122 may be folded inwardly prior to folding of other strip portions of the foil portion 106, such as prior to folding the second strip portion 124. As another example, the first strip portion 126 may be folded inwardly prior to folding of other strip portions of the foil portion 108, such as prior to folding the second strip portion 128.

In some implementations, the roll configuration 150 may be subject to multiple folding operations during the folding process 160, such as where strip portions of the foil portion 106 are folded via the rotary tool 162 prior to or after folding strip portions of the foil portion 108. To illustrate, the folding process 160 may include folding strip portions of the foil portion 106 via the rotary tool 162, rotating the roll configuration 150 to expose strip portions of the foil portion 108 to the rotary tool 162, and folding the strip portions of the foil portion 108 via the rotary tool 162. In some other implementations, the strip portions of the foil portions 106, 108 may be folded concurrently, such as by using two rotary tools 162 and by positioning the roll configuration 150 between the two rotary tools 162.

FIG. 1H illustrates certain additional aspects associated with an example of the battery fabrication process 100. In FIG. 1H, the roll configuration 150 includes bent portions of different widths that are bent inwardly toward the axis 154 of the roll configuration 150. For example, the plurality of strip portions formed on the foil portion 106 of the cathode 102 may be bent radially inwardly toward the axis 154 of the roll configuration 150 to create bent portions 170 that define a first edge (e.g., a first cylinder base) of the roll configuration 150. As another example, the plurality of strip portions formed on the foil portion 108 of the anode 104 may be bent radially inwardly toward the axis 154 of the roll configuration 150 to create bent portions 172 that define a second edge (e.g., a second cylinder base) of the roll configuration 150, such as an edge 174, as illustrated in the example of FIG. 1I.

In some implementations, the bent portions 170, 172 may be bent at one or more angles or within a range of angles associated with the battery fabrication process 100. To illustrate, the battery fabrication process 100 may specify that the bent portions 170, 172 are to be bent at a target angle of 90 degrees (viewing from the end surface with respect to the axis 154 of the roll configuration 150) within a tolerance range (such as plus or minus 10 percent). In this illustrative example, one or more of the bent portions 170, 172 may be bent at an angle of 81 degrees, 90 degrees, or 99 degrees (with respect to the axis 154 of the roll configuration 150). In other examples, the target angle may correspond to another angle, such as an acute angle (e.g., 75 degrees) or an obtuse angle (e.g., 100 degrees), as illustrative examples. In addition, the rotary tool 162 may be configured to operate based on the target angle and may be adjustable within a range of target angles. For example, an amount of force applied by the rotary tool 162 may be based on the target angle associated with the bent portions 170, 172. The target angle or range of angles may be input to a computer or controller that is coupled to and configured to operate the rotary tool 162, and the computer or controller may provide a control signal to the rotary tool 162 based on the target angle or range of angles.

In some implementations, the bent portions 170, 172 (i.e. the foil portions) are bent toward the axis 154 of the roll configuration 150. The outside foil portion having larger width will fold over the inner foil portion having smaller width. To facilitate the folding, the foil portions can be formed with slits so that the foil portions forms several circular sectors. A tool/blade can be provided to push a circular sector toward the axis 154 in order to fold the foil portions.

After performing the folding process 160, the plurality of bent portions of the cathode 102 may include first strip portions associated with the first region 112 that are disposed at a first radial distance from the axis 154 of the roll configuration 150 and may further include second bent portions formed on the second region 114 that are disposed at a second radial distance from the axis 154 of the roll configuration 150, where the second distance is greater than the first distance. For example, bending the first strip portion 122 and the second strip portion 124 may create a first bent portion and a second bent portion of the cathode 102, where the first bent portion has a greater radial distance from the axis 154 of the roll configuration 150 as compared to the second bent portion. As another example, bending the first strip portion 126 and the second strip portion 128 may create a first bent portion and a second bent portion of the anode 104, where the first bent portion has a greater radial distance from the axis 154 of the roll configuration 150 as compared to the second bent portion.

Further, the first bent portions may have a greater length as compared to the second strip portions. For example, the first bent portions may have a first length corresponding to the width W1, and the second bent portions may have a second length corresponding to the width W2, where the first length is greater than the second length.

FIG. 1J illustrates certain additional aspects associated with an example of the battery fabrication process 100. The example of FIG. 1J illustrates that, after performing the folding process 160, the battery fabrication process 100 may include performing an assembly process 190 to form a battery 180, such as a Lithium-ion battery (LiB). The assembly process 190 may include attaching one or more components to the battery 180 (e.g., one or more cell assembly operations), integrating the battery 180 within another device, or a combination thereof. In some implementations, the assembly process 190 may include attaching a weld plate 194 to the bent portions 170 and attaching a weld plate 196 to the bent portions 172 (e.g., at the edge 174). In some examples, the weld plates 194, 196 are attached to the bent portions 170, 172 using a welding process. The weld plates 194, 196 may provide electrically conductive surfaces associated with the battery 180.

In some implementations, the assembly process 190 may include attaching a cap 192 of the battery 180 to the weld plate 194 (e.g., using a cap scaling process or a cap welding process) and may include attaching a base 198 of the battery 180 to the weld plate 196 (e.g., using a welding process, such as a bottom welding process, to connect the base 198 to the weld plate 196 via a base contact 199). To further illustrate, in some examples, the weld plate 194 includes a tab 195 (e.g., a protrusion of the weld plate 194) that may be welded to the cap 192. Depending on the particular implementation, the assembly process 190 may further include one or more other operations, such as attaching a can of the battery 180 (e.g., to the weld plate 194 via a can insertion operation), attaching a header of the battery 180 (e.g., to the weld plate 196), attaching a housing to the roll configuration 150 (e.g., by inserting the roll configuration 150 within the housing after attaching the weld plates 194, 196 to the roll configuration 150), performing a crimping operation, performing electrolyte injection, performing a scaling operation, performing one or more other operations, or a combination thereof.

In some examples, the folding process 160 may create relatively smooth or flat edges of the roll configuration 150. As a result, in some implementations, the foil portions 108 may not be subject to a rubbing process. Avoiding a rubbing process may reduce cost associated with the battery fabrication process 100 (e.g., by avoiding the use of specialized tools or equipment that perform the rubbing process). Further, because a rubbing process may be associated with product damage or wear in certain cases, avoiding a rubbing process may increase product yield associated with the battery fabrication process 100.

In some implementations, an impedance associated with the battery 180 is based at least in part on the number (or cardinality) of bent portions included in the battery 180. For example, in some implementations, each bent portion may include or correspond to a conductive channel between the cathode 102 and a can of the battery 180 or between the anode 104 and a header of the battery 180. As a result, in some implementations, an impedance associated with the battery 180 may be decreased by increasing the number of bent portions of the battery 180 (such as by decreasing widths of the bent portions). In some implementations, a target impedance of the battery 180 may be adjusted during manufacturing (such for different applications or implementations of the battery 180) by adjusting the number of bent portions, which may be relatively inexpensive as compared to some other battery impedance adjustment techniques.

Although certain examples are depicted in FIGS. 1A-1J for illustration, it is noted that other examples are also within the scope of the disclosure. For example, although FIG. 1B illustrates that a stepped pattern (including the regions 112, 114, 116, and 118) may be formed on one or both of the foil portions 106, 108, in other implementations, another pattern may be formed on one or both of the foil portions 106, 108 (alternatively or in addition to a stepped pattern). As an example, a relatively “smooth” or linear gradient pattern, a curved pattern, or another pattern may be formed on one or both of the foil portions 106, 108. Further, although the example of FIG. 1B illustrates four regions on each of the foil portions 106, 108, in other implementations, a different number of regions may be formed on one or both of the foil portions 106, 108 (e.g., two regions, three regions, five regions, or another number of regions). Additionally, although the example of FIG. 1C illustrates five strips formed on each region of the foil portions 106, 108, in other implementations, a different number of strips may be formed on one or more regions of the foil portions 106, 108 (e.g., two strips, three strips, four strips, five strips, or another number of strips).

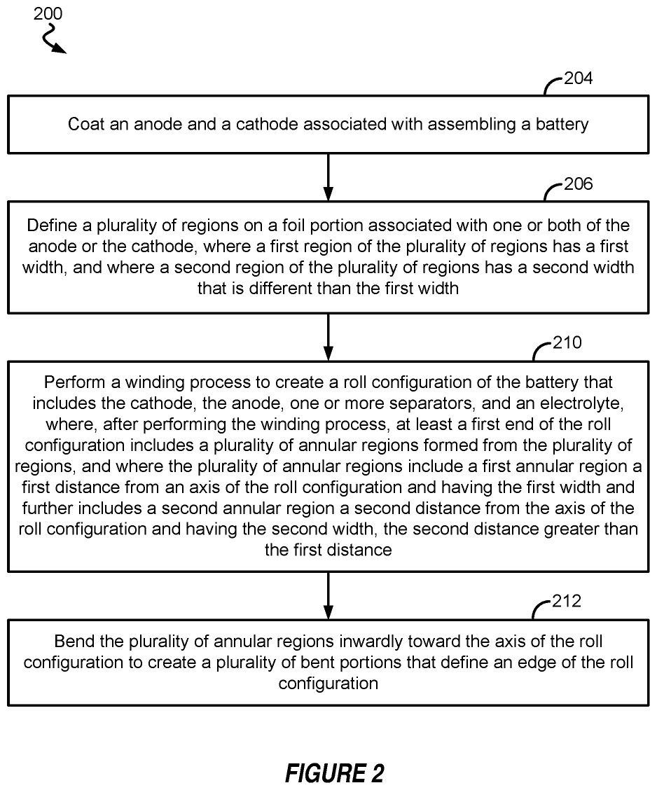

FIG. 2 is a flow chart illustrating an example of a method 200 of battery fabrication. In some examples, the method 200 is performed to fabricate the battery 180. Operations of the method 200 may be initiated, performed, or controlled by fabrication equipment, which may include one or more of a processor, a memory, or the rotary tool 162 of FIG. 1G.

The method 200 includes coating an anode and a cathode associated with assembling the battery, at 204. For example, the cathode and the anode may correspond to the cathode 102 and the anode 104, respectively. To further illustrate, the cathode 102 may be manufactured by coating a cathode material on a foil while leaving an uncoated portion (e.g., the foil portion 106), and the anode 104 may be manufactured by coating an anode material on a foil while leaving an uncoated portion (e.g., the foil portion 108).

The method 200 further includes defining a plurality of regions on a foil portion associated with one or both of the anode or the cathode, at 206. A first region of the plurality of regions has a first width, and a second region of the plurality of regions has a second width that is different than the first width. For example, the plurality of regions may include the first region 112 and the second region 114. The first region 112 may have the first width W1, and the second region 114 may have the second width W2. As another example, the plurality of regions may include the first region 116 and the second region 118. The first region 116 may have the first width W1, and the second region 118 may have the second width W2.

The method 200 may optionally include defining a plurality of strip portions in the plurality of regions of the foil portion. For example, the plurality of strip portions may include any of the strip portions 122 and 124. Alternatively or in addition, the plurality of strip portions may include the strip portions 126 and 128.

The method 200 further includes performing a winding process to create a roll configuration of the battery that includes the cathode, the anode, one or more separators, and an electrolyte, at 210. For example, the winding process 140 may be performed to create the roll configuration 150. After performing the winding process 140, at least a first end of the roll configuration 150 includes a plurality of annular regions formed from the plurality of regions. The plurality of annular regions include a first annular region a first distance from an axis of the roll configuration and having the first width and further includes a second annular region a second distance from the axis of the roll configuration and having the second width. The second distance is greater than the first distance. As referred to herein, “annular” may refer to a substantially circular, elliptical, or other curved shape. In some fabrication processes, a polygonal shape may approximate and may be referred to as “annular” if the polygonal shape approximates a circular, elliptical, or other curved shape.

The method 200 further includes bending the plurality of annular regions inwardly toward an axis of the roll configuration to create a plurality of bent portions that define an edge of the roll configuration, at 212. For example, the folding process 160 may be performed to create the bent portions 170, the bent portions 172, or both. In some examples, the width of the plurality of bent portions may be gradually changed (e.g., as a result of the different widths illustrated in FIG. 1B).

In some implementations of the method 200, the plurality of bent portions include first bent portions associated with a first region (such as the first region 112) and that are disposed at a first radial distance from the axis 154 of the roll configuration 150. The plurality of bent portions may further include second bent portions formed on a second region (such as the second region 114) and that are disposed at a second radial distance from the axis 154 of the roll configuration 150. The second radial distance may be greater than the first radial distance, and the width of the second bent portions may be larger than the width of the first bent portions. Each of the first bent portions and the second bent portions may include a plurality of bent strip portions by forming slits therein (such as using a laser cutting process to form the strip portions of FIG. 1C). The second bent strip portions may be bent over the first bent portions (e.g., using the folding process 160).

Although certain materials have been described generally, those of skill in the art will recognize that a suitable material may be selected based on the particular application. To illustrate, in some implementations, the foil portions 106, 108 include one or more of an aluminum (Al) material, a copper (Cu) material, or another material. To further illustrate, depending on the particular implementation, the cathode 102 and the anode 104 may each include a planar body (e.g., a sheet or a panel) coated with or formed from a cathode material (such as a lithium metal oxide, alloy, or compound), an olivine, a spinel, an anode material (such as graphite, graphene, silicon, or silicon oxide), or another material. In some implementations, an electrolyte is disposed within the roll configuration 150. The electrolyte may include an organic solvent, a polymer electrolyte, a ceramic solid electrolyte, an ionic liquid electrolyte, or another material, as illustrative examples. Further, one or more separators (such as the separator 142) may include one or more polyolefin materials, such as polypropylene or polyethylene, and may be coated with a ceramic layer on one or more sides for mechanical strength. In some examples, the separator 142 includes multiple layers, such as two layers.

A battery described herein may be integrated into an electronic device. In some implementations, multiple batteries may be integrated into a battery pack of an electronic device. Examples of electronic devices include various portable or cordless devices, such as power tools (e.g., drills, saws, grass trimmers, blowers, sanders, etc.), small appliances (e.g., mixers, blenders, coffee grinders, etc.), communications devices (e.g., smartphones, personal digital assistants, etc.), and office equipment (e.g., computers, tablets, printers, etc.). Further, although examples of batteries and battery packs have been described with reference to use in various portable or cordless devices, it should be appreciated that use of such batteries and battery packs is not so limited. Batteries and battery packs configured to provide high power and high energy density in accordance with examples herein may, for example, be utilized in powering such devices as electric vehicles, backup/uninterruptable power supplies, etc.

Although certain examples have been described, it should be understood that various changes, substitutions and alterations can be made herein without departing from the spirit and scope of the disclosure. Moreover, the scope of the disclosure is not intended to be limited to the particular examples of the process, machine, manufacture, composition of matter, means, methods, and steps described in the specification. As one of skill in the art will readily appreciate from the disclosure, processes, machines, manufacture, compositions of matter, means, methods, or steps, presently existing or later to be developed that perform substantially the same function or achieve substantially the same result as the corresponding examples described herein may be utilized. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A battery comprising:
an anode;
a cathode;
one or more separators; and
an electrolyte, wherein the anode, the cathode, the one or more separators, and the electrolyte are disposed in a roll configuration, and wherein at least one of the anode or the cathode includes a foil portion having a plurality of bent portions in different widths that are bent inwardly toward an axis of the roll configuration and that define an edge of the roll configuration.

2. The battery of claim 1, wherein the plurality of bent portions include first bent portions formed on a first region of a plurality of regions of the foil portion and that are disposed at a first radial distance from the axis of the roll configuration, wherein the plurality of bent portions further include second bent portions formed on a second region of the plurality of regions of the foil portion and that are disposed at a second radial distance from the axis of the roll configuration, wherein the second radial distance is greater than the first radial distance, and wherein the width of the second bent portions is larger than the width of the first bent portions.

3. The battery of claim 2, wherein the first bent portions have a first length, and wherein the second bent portions have a second length that is greater than the first length.

4. The battery of claim 2, wherein the first bent portions and the second bent portions comprise a plurality of bent strip portions by forming slits therein.

5. The battery of claim 2, wherein the second bent portions are folded over the first bent portions.

6. The battery of claim 1, wherein the width of the plurality of bent portions is gradually changed.

7. A method of fabrication of a battery, the method comprising:
coating an anode and a cathode associated with assembling the battery;
defining a plurality of regions on a foil portion associated with one or both of the anode or the cathode, wherein a first region of the plurality of regions has a first width, and wherein a second region of the plurality of regions has a second width that is different than the first width;
performing a winding process to create a roll configuration of the battery that includes the cathode, the anode, and one or more separators, wherein, after performing the winding process, at least a first end of the roll configuration includes a plurality of annular regions formed from the plurality of regions, and wherein the plurality of annular regions include a first annular region a first distance from an axis of the roll configuration and having the first width and further includes a second annular region a second distance from the axis of the roll configuration and having the second width, the second distance greater than the first distance; and
bending the plurality of annular regions inwardly toward the axis of the roll configuration to create a plurality of bent portions that define an edge of the roll configuration.

8. The method of claim 7, wherein the plurality of bent portions include first bent portions associated with the first width and further include second bent portions associated with the second width, and wherein the second width of the second bent portions is larger than the first width of the first bent portions.

9. The method of claim 8, wherein the first bent portions have a first length, and wherein the second bent portions have a second length that is greater than the first length.

10. The method of claim 8, wherein each of the first bent portions and the second bent portions comprises a plurality of bent strip portions by forming slits therein.

11. The method of claim 8, wherein the second bent portions are folded over the first bent portions.

12. The method of claim 7, wherein the width of the plurality of bent portions is gradually changed.

13. The method of claim 7, further comprising defining a plurality of strip portions in the plurality of regions of the foil portion.

14. The method of claim 13, wherein defining the plurality of strip portions includes laser cutting the plurality of regions.

15. The method of claim 7, wherein defining the plurality of regions includes laser cutting the foil portion.

16. The method of claim 7, wherein bending the plurality of portions inwardly toward the axis of the roll configuration includes sequentially applying forces to the plurality of portions using a rotary tool.

17. A lithium-ion battery (LiB) comprising:
a first electrode;
a second electrode;
one or more separators; and
an electrolyte, wherein the first electrode, the second electrode, the one or more separators, and the electrolyte are disposed in a roll configuration, and wherein at least one of the first electrode or the second electrode includes a foil portion having a plurality of bent portions that are bent inwardly toward an axis of the roll configuration and that define an edge of the roll configuration.

18. The LiB of claim 17, wherein the plurality of bent portions include first bent portions formed on a first region of a plurality of regions of the foil portion and that are disposed at a first radial distance from the axis of the roll configuration, wherein the plurality of bent portions further include second bent portions formed on a second region of the plurality of regions of the foil portion and that are disposed at a second radial distance from the axis of the roll configuration, wherein the second distance is greater than the first distance, and wherein the width of the second bent portions is larger than the width of the first bent portions.

19. The LiB of claim 18, wherein the first bent portions have a first length, and wherein the second bent portions have a second length that is greater than the first length.

20. The LiB of claim 18, wherein each of the first bent portions and the second bent portions comprises a plurality of bent strip portions by forming slits therein.
